(19) United States
(12) Patent Application Publication
(10) Pub. No.: US 2023/0206769 A1
(43) Pub. Date: Jun. 29, 2023

(54) METHOD AND DEVICE FOR EVALUATING TRUCK PLATOONING STRATEGY BASED ON FUEL SAVING RATE

(71) Applicant: Tongji University, Shanghai (CN)

(72) Inventors: Huailei CHENG, Shanghai (CN); Lijun SUN, Shanghai (CN); Liping LIU, Shanghai (CN); Tian JIN, Shanghai (CN)

(21) Appl. No.: 17/709,067

(22) Filed: Mar. 30, 2022

(30) Foreign Application Priority Data
Dec. 23, 2021 (CN) 202111591816.2

(51) Int. Cl. G08G 1/00; B60W 40/12; B60W 40/105

(52) U.S. Cl. CPC G08G 1/22; B60W 40/12; B60W 40/105; B60W 2530/209

(57) ABSTRACT

A method and device for evaluating truck platooning strategy based on fuel saving rate is provided, which is applied to the technical field of transportation engineering, the method comprising: S1: obtaining the truck platooning strategy, and judging whether the truck platooning strategy has been determined; S2: when the truck platooning strategy has been determined, obtaining fuel-consumption-related parameters of each truck in the truck queue, calculating the fuel saving rate of each truck in the truck queue based on the obtained s parameters, calculating the average fuel saving rate of whole truck queue based on the fuel saving rate of each truck, and evaluating the truck platooning strategy based on the average fuel saving rate. The present disclose can evaluate the fuel economy in the case of different truck types and different platooning strategies.

### CROSS REFERENCE TO RELATED APPLICATION

This patent application claims the benefit and priority of Chinese Patent Application No. 202111591816.2, filed on Dec. 23, 2021, the disclosure of which is incorporated by reference herein in its entirety as part of the present application.

### TECHNICAL FIELD

The disclosure relates to the technical field of transportation engineering, and more particularly to a method and device for evaluating the truck platooning strategy based on the fuel saving rate.

### BACKGROUND ART

Carbon emissions caused by truck fuel consumption of road transportation system are the main component of carbon emissions in the transportation field. It is of great significance to reduce the truck fuel consumption in road transportation and improve the level of energy saving and emission reduction of road transportation.

In recent years, truck platooning technology has gradually become a popular research field in road transportation system. Under the condition of platoon traveling, the space between trucks is shortened, and the leading truck offsets most of the air resistance and reduces the drag coefficient of subsequent trucks, which accordingly reduces the fuel consumption of the entire truck queue system, improves the fuel economy of the queue, and effectively reduces the carbon emissions during truck traveling.

At the present stage, although some studies have analyzed the fuel economy of trucks traveling in a platooning mode, the existing studies have not considered the parameters of the truck type and the platooning mode sufficiently, and the platooning truck type studied is relatively single, failing to properly evaluate the fuel economy of different types of trucks organized with different platooning strategies. Furthermore, few studies aim to investigate the method for guiding truck platooning with the objective of optimizing the truck queue's overall fuel economy. Hence, it is necessary to further study the optimization method of truck platoon based on fuel economy optimization, so as to further reduce the fuel consumption of truck queue and minimize the emission of truck queue.

### SUMMARY

In view of this, the present disclosure provides a method and device for evaluating truck platooning strategy based on fuel saving rate. The method can evaluate the performance in case of different truck types and different platooning strategies based on an indicator namely average fuel saving rate, and can also provide an optimization tool for developing an optimal truck platoon strategy to minimize the fuel consumption of the whole truck queue.

In order to achieve the above object, the present disclosure adopts the following technical solutions:

A method for evaluating truck platooning strategy based on the fuel saving rate, the method comprising:

S1: obtaining a truck platooning strategy, and judging whether the truck platooning strategy for organizing truck queue has been determined or not;
S2: when the truck platooning strategy has been determined, obtaining the fuel-consumption-related parameters of each truck in the truck queue, then calculating the fuel saving rate of each truck in the truck queue based on the obtained parameters, then calculating the average fuel saving rate of the whole truck queue based on the fuel saving rate of each truck, and finally evaluating the truck platooning strategy based on the average fuel saving rate.
Preferably, in the step S2, the fuel-consumption-related parameters include the truck's length, velocity, weight, platooning spacing distance, position in a queue, and the front area.
Preferably, in the step S2, the model for calculating the fuel saving rate of each truck in a truck queue is:

$$Δ FC = \frac{0.4332 * {e}^{0.0086 * S} [ a * ln ( S ) + b ] * {L}^{C}}{1 + \frac{{r}_{0} mg}{\frac{1}{2} ρ {v}^{2} A * ( 0.014 L + 0.3659 )}}$$

where, ΔFC is the fuel saving rate, L is the length of the truck, S is the spacing between two adjacent trucks, r₀ is the truck rolling coefficient, m is the weight of the truck, v is the truck velocity, ρ is the air density, A is the front area of the truck, and g is the gravity acceleration, a, b and c are fitting coefficients related to the location of the truck in a truck queue.
Preferably, in the step S2, the model for calculating the average fuel saving rate of a truck queue is:

$$\overline{Δ FC} = \frac{{\sum }_{i = 1}^{n} ( Δ {FC}_{i} * {FC}_{i} )}{{{\sum }_{i = 1}}^{n} {FC}_{i}}$$

where, Δ̅F̅C̅ is the average fuel savings rate of a truck queue, n is the number of trucks of a truck queue, ΔFCᵢ is the fuel saving rate of the ith truck in the queue, and FCᵢ is the fuel consumption of the ith truck.
Preferably, the method further comprises a step S3:
when the truck platooning strategy has not been determined, the method provides a tool for developing an optimal truck platooning strategy to minimize the fuel consumption of the whole truck queue;
first, acquiring the numbers and types of all trucks that used for platooning and the allowed truck number in a truck queue; determining all possible truck platooning queues based on the truck type and the allowed truck number in a truck queue; then, calculating the average fuel saving rate of each truck platooning queue based on the procedure presented in S2; then ranking the preferred truck platooning queue based on the fuel saving rate calculation results; then organizing the trucks successively into the platooning queue with a lower fuel saving rate until all the trucks are assigned to the truck queue.
Preferably, in the step S3, the specific method for determining all possible truck platooning queues based on the truck type and the allowed truck number in a truck queue includes:
determining the number of truck type as m and the allowed truck number in a truck platooning strategy as n, then determining a total of mⁿ types of possible truck platooning queues.
Preferably, in the step S3, the specific procedure of organizing the trucks successively into the platooning queue with a lower fuel saving rate based on the ranking result of the possible truck platooning queues includes:
determining the maximum platooning number Nₘₐₓ that can be achieved for a specific platooning queue based on the type and number of all trucks that need to be platooned, by using the following function:

$${N}_{max} = min ( [ \frac{{M}_{{A}_{1}}}{{M}_{{A}_{1}}^{p}} ] , [ \frac{{M}_{{B}_{2}}}{{M}_{{B}_{2}}^{p}} ] , … , [ \frac{{M}_{{X}_{n}}}{{M}_{{X}_{n}}^{p}} ] )$$

where, min is the minimum value function, square brackets [ ] represent the rounding function, M_{A}_{₁}, M_{B}_{₂}, . . . , M_{X}_{ₙ} are is the numbers of different types of trucks that need to be platooned, and M_{A}_{₁}^{p}, M_{B}_{₂}^{p}, . . . , M_{X}_{ₙ}^{p} are is the numbers of different types of trucks in a specific platooning queue.

Following the results of the ranking of the preferred truck platooning queues in Step S3 to calculate the Nₘₐₓ for each truck platooning queue, until all trucks are assigned into the corresponding platooning queue.

Further, the present disclosure provides a device for evaluating a truck platooning strategy, the device comprising: a strategy acquisition module, a judgment module, a first data acquisition module, a second data acquisition module, and an evaluation module;

the strategy acquisition module is connected to the judgment module, an output end of the judgment module is connected to input ends of the first data acquisition module and the second data acquisition module, and output ends of the first data acquisition module and the second data acquisition module are connected to the evaluation module;
the strategy acquisition module is configured to obtain the truck platooning strategy, the judgment module is configured to judge whether the truck platooning strategy has been determined or not, the first data acquisition module is configured to obtain fuel-consumption-related parameters of each truck in the truck queue, and the second data acquisition module is configured to obtain the fuel-consumption-related parameters of each truck in a corresponding truck queue when the truck platooning strategy has not been determined, and the evaluation module is configured to determine the fuel saving rate of each truck in the truck queue according to the obtained parameters, to determine an average fuel saving rate of each truck in the truck queue based on fuel saving rate of each truck, and to evaluate the truck platooning strategy based on the average fuel saving rate.

Further, the present disclosure also provides a computer-readable storage medium, which stores a computer program for electronic data exchange, wherein, the computer program is operable to cause a computer to execute any one of above-described methods.

It can be seen from the above technical solutions that, compared with the prior art, the present disclosure provides a method and device for evaluating truck platooning strategy based on fuel saving rate, which can evaluate performance in case of different truck types and different modes of platooning based on the average fuel saving rate. In addition, the method provides an optimization tool for developing an optimal truck platoon strategy to minimize the fuel consumption of the whole truck queue.

### BRIEF DESCRIPTION OF THE DRAWINGS

In order to more clearly explain the embodiments of the present disclosure or the technical solutions in the prior art, the drawings that need to be used in the description of the embodiments or the prior art will be briefly introduced as follows. Obviously, the drawings in the following description are only the embodiments of the present disclosure. For those of ordinary skill in the art, other drawings can be obtained based on the provided drawings herein without creative work.

FIG. 1 is an operation flow chart of a method for evaluating truck platooning strategies based on fuel saving rate according to the present disclosure;

FIG. 2 is a block diagram of the structure and principle of a truck platooning strategy evaluation device based on fuel saving rate according to the present disclosure.

### DETAILED DESCRIPTION

The technical solutions according to the embodiments of the present disclosure will be clearly and completely described below in conjunction with the accompanying drawings according to the embodiments of the present disclosure. Obviously, the described embodiments are only a part of the embodiments of the present disclosure, rather than all the embodiments. All the other embodiments obtained by those of ordinary skill in the art based on the embodiments of the present disclosure without creative work all fall within the protection scope of the present disclosure.

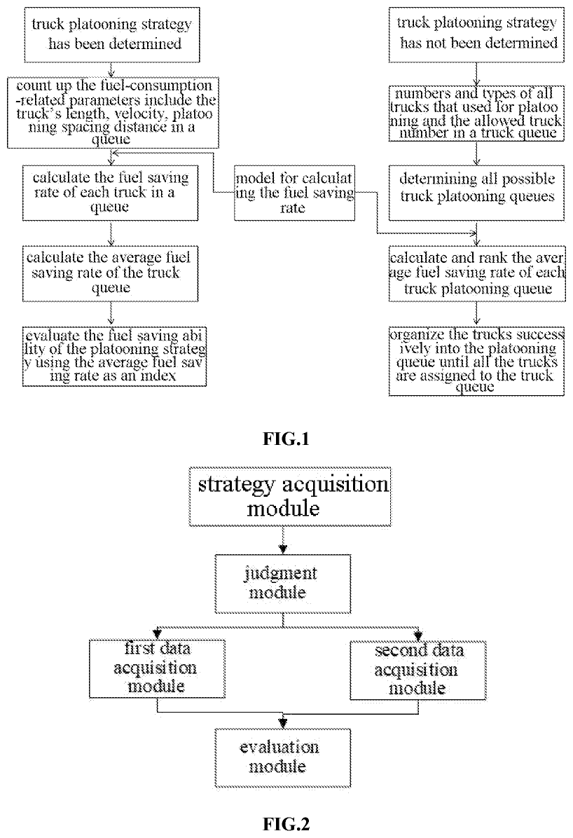

Referring to FIG. 1, an embodiment of the present disclosure discloses a method for evaluating a truck platooning strategy based on the fuel saving rate, the method includes:

S1: obtaining a truck platooning strategy, and judging whether the truck platooning strategy for organizing truck queue has been determined or not;
S2: when the truck platooning strategy has been determined, obtaining the fuel-consumption-related parameters of each truck in the truck queue, then calculating the fuel saving rate of each truck in the truck queue based on the obtained parameters, then calculating the average fuel saving rate of the whole truck queue based on the fuel saving rate of each truck, and finally evaluating the truck platooning strategy based on the average fuel saving rate.

According to a specific embodiment, in the step S2, the fuel-consumption-related parameters include the truck's length, velocity, weight, platooning spacing distance, position in a queue, and the front area.

According to a specific embodiment, in the step S2, the model for calculating the fuel saving rate of each truck in a truck queue is:

$$Δ F C = \frac{0.4332 * {e}^{0.0086 * S} [ a * ln ( S ) + b ] * {L}^{C}}{1 + \frac{{r}_{0} m g}{\frac{1}{2} ρ {v}^{2} A * ( 0.014 L + 0.3659 )}}$$

where, ΔFC is the fuel saving rate, L is the length of the truck, S is the spacing between two adjacent trucks, r₀ is the truck rolling coefficient, m is the weight of the truck, v is the truck velocity, ρ is their density, A is the front area of the truck, and g is the gravity acceleration, a, b and c are fitting coefficients related to the location of the truck in a truck queue.

According to a specific embodiment, in step S2, the model for calculating the average fuel saving rate is:

$$\overline{Δ FC} = \frac{{\sum }_{i = 1}^{n} ( Δ {FC}_{i} * {FC}_{i} )}{{{\sum }_{i = 1}}^{n} {FC}_{i}}$$

where, Δ̅F̅C̅ is the average fuel savings rate of a truck queue, n is the number of trucks of a truck queue, ΔFCᵢ is the fuel saving rate of the ith truck in the queue, and FCᵢ is the fuel consumption of the ith truck.

According to a specific embodiment, the method further includes a step S3:

when the truck platooning strategy has not been determined, the method provides a tool for developing an optimal truck platoon strategy to minimize the fuel consumption of the whole truck queue;
first acquiring the numbers and types of all trucks that used for platooning and the allowed truck number in a truck queue; determining all possible truck platooning queues based on the truck type and the allowed truck number in a truck queue;
then calculating the average fuel saving rate of each truck platooning queue based on the procedure presented in S2; then ranking the preferred truck platooning queue based on the fuel saving rate calculation results; then organizing the trucks successively into the platooning queue with a lower fuel saving rate until all the trucks are assigned to the truck queue.

According to a specific embodiment, in the step S3, the specific method for determining all possible truck platooning queues based on the truck type and the allowed truck number in a truck queue includes:

determining the number of truck type as m and the allowed truck number in a truck platooning strategy as n, then determining a total of mⁿ types of possible truck platooning queues.

According to a specific embodiment, in the step S3, the specific procedure of organizing the trucks successively into the platooning queue with a lower fuel saving rate based on the ranking result of the possible truck platooning queues includes:

determining the maximum platooning number Nₘₐₓ that can be achieved for a specific platooning queue based on the type and number of all trucks that need to be platooned, by using the following function:

$${N}_{max} = min ( [ \frac{{M}_{{A}_{1}}}{{M}_{{A}_{1}}^{p}} ] , [ \frac{{M}_{{B}_{2}}}{{M}_{{B}_{2}}^{p}} ] , … , [ \frac{{M}_{{X}_{n}}}{{M}_{{X}_{n}}^{p}} ] )$$

where, min is the minimum value function, square bracket [ ] represents the rounding function, M_{A}_{₁}, M_{B}_{₂}, . . . , M_{X}_{ₙ} are the numbers of different types of trucks that needs to be platooned, and M_{A}_{₁}^{p}, M_{B}_{₂}^{p}, . . . , M_{X}_{ₙ}^{p} are the numbers of different types of trucks in a specific platooning queue.

Following the ranking results of the preferred truck platooning queues in Step S3 to calculate the Nₘₐₓ for each truck platooning queue, until all trucks are assigned into the corresponding platooning queue.

According to the method provided by the embodiment of the present disclosure, the truck queue is organized according to the ranking results of the fuel economy of the platoon strategies, therefore the resulting platooning strategy has the best fuel saving rate.

Specifically, the derivation of the model for calculating the fuel saving rate illustrated is as follows:

The equation for calculating the fuel consumption of a truck during operation is:

$$FC = α λ v ( {r}_{0} m g + \frac{1}{2} ρ {v}^{2} A {C}_{D} ) \qquad ( 1 )$$

where, α is the efficiency coefficient, λ is the power-velocity characteristic curve, r₀ is the rolling coefficient, m is the weight of the truck, v is the truck velocity, ρ is the air density, A is the front area of the truck, CD is the drag coefficient, and g is the gravity acceleration.

If a truck is organized in a truck queue, the drag coefficient CD will be reduced. As a result, the fuel consumption of the truck will also be saved. The corresponding saving rate of the fuel is calculated as:

$$Δ F C = \frac{F {C}_{0} - F {C}_{1}}{F {C}_{0}} \qquad ( 2 )$$

where, FC₀ is the fuel consumption of trucks without platooning, and FC₁ is the fuel consumption of trucks in a queue.

Substituting equation (1) into equation (2), the final calculation equation of the fuel saving rate ΔFC can be obtained as below:

$$Δ F C = \frac{\frac{1}{2} ρ {v}^{2} A ( {C}_{D 0} - {C}_{D 1} )}{{r}_{0} m g + \frac{1}{2} ρ {v}^{2} A {C}_{D 0}} \qquad ( 3 )$$

where, C_{D0} is the drag coefficient of trucks without platooning, C_{D1} is the drag coefficient of the truck in a queue, and g is the gravity acceleration.

By means of a simulation software STAR-CCM, the drag coefficients of truck queue with 3 types and 16 truck platooning queues are calculated, the drag coefficients C_{D0} and C_{D1} for different types of trucks with various lengths are obtained and fitted. The fitting results for those drag coefficients are shown as below:

$${C}_{D 0} = 0 \text{.014} \cdot L + 0.3659 \qquad ( 4 )$$

$$\frac{{C}_{D 0} - {C}_{D 1}}{{C}_{D 0}} = [ a \cdot ln ( S ) + b ] \cdot {L}^{c} \qquad ( 5 )$$

where, L is the truck length, S is the spacing between two trucks in a queue, and a,b, and c are the fitting coefficients related to the position of a truck in a queue, which are determined according to Table 1:

TABLE 1
Fitting coefficients of parameters a, b, c

| Position of a truck in a truck | | | |
|---|---|---|---|
| queue | a | b | c |
| Head | −0.0218 | 0.0948 | 0.503 |
| Middle | −0.0438 | 0.2365 | 0.4621 |
| Tail | −0.04506 | 0.3008 | 0.3275 |

Finally, by substituting equation (4) and equation (5) into equation (3), the model for calculating the fuel saving rate can be obtained as follows:

$$Δ FC = \frac{[ a \cdot ln ( S ) + b ] \cdot {L}^{c}}{1 + \frac{{r}_{0} m g}{\frac{1}{2} ρ {v}^{2} A \cdot ( 0.014 \cdot L + 0.3659 )}} \qquad ( 6 )$$

In order to improve the calculation accuracy, the equation (6) is further modified with reference to the field measured data of fuel saving rate of the truck platoon. Finally, the updated calculation model for the fuel saving rate can be obtained as that illustrated in Step S2.

Specifically, all of the above-mentioned processes can be implemented by a computer program.

Referring to FIG. 2, an embodiment of the present disclosure further provides a device for evaluating a truck platooning strategy, the device comprising: a strategy acquisition module, a judgment module, a first data acquisition module, a second data acquisition module, and an evaluation module; The strategy acquisition module is connected to the judgment module, an output end of the judgment module is connected to input ends of the first data acquisition module and the second data acquisition module, and output ends of the first data acquisition module and the second data acquisition module are connected to the evaluation module;

The strategy acquisition module is configured to obtain the truck platooning strategy, the judgment module is configured to judge whether the truck platooning strategy has been determined or not, the first data acquisition module is configured to obtain fuel-consumption-related parameters of each truck in the truck queue, and the second data acquisition module is configured to obtain fuel-consumption-related parameters of each truck in the corresponding truck queue when the truck platooning strategy has not been determined, and the evaluation module is configured to determine the fuel saving rate of each truck in the truck queue according to the obtained parameters, to determine the average fuel saving rate of each truck in the truck queue based on the fuel saving rate of each truck, and evaluate the truck platooning strategy based on the average fuel saving rate.

An embodiment of the present disclosure also provides a computer-readable storage medium, which stores a computer program for electronic data exchange, wherein, the computer program is operable to cause a computer to execute a method as in any one of the above-mentioned embodiments.

The specific implementation process of the method provided by the embodiment of the present disclosure is as follows:

When the truck platooning strategy has been determined for a highway, the method of the present disclosure can be used to assess the fuel saving rate of this platoon strategy. For example, three types of trucks (named T₁, T₂ and T₃, respectively) are used for platooning. The number of trucks allowed in a truck queue is 3, that is, three trucks are platooned into a queue group. The information of three types of trucks are shown in Table 2, while the proposed platooning strategies are shown in Table 3.

TABLE 2
Basic information of three truck types

| | Truck | | Front | Fuel consumption |
|---|---|---|---|---|
| Truck | length | Truck weight | windward | per |
| type | (m) | (kg) | area (m²) | 100 kilometers (L) |
| T₁ | 5.8 | 15000 | 6.6 | 15 |
| T₂ | 7.3 | 20000 | 8.7 | 20 |
| T₃ | 16.6 | 30000 | 10.7 | 40 |

TABLE 3
Numbers of truck queue

| Truck platooning queue | Numbers of truck queue |
|---|---|
| T₁-T₁-T₂ | 100 |
| T₁-T₂-T₂ | 200 |
| T₁-T₂-T₃ | 300 |

The truck velocity of the platoon is v=25 m/s, the air density=1.2 kg/m3, the rolling coefficient r₀=0.006, and the spacing between the trucks in the truck platoon is 8 m. Combining the truck information and the fuel saving rate calculation model, it can be calculated that for the “T₁-T₁-T₂” queue, the fuel saving rate of the T₁ truck at the head position is 3.09%, and the fuel saving rate of the T₁ truck at the middle position is 7.88%, and the fuel saving rate of the T₃ truck at the tail position is 13.90%; similarly, the fuel saving rates of the three trucks in the “T₁-T₂-T₂” queue can be calculated as 3.09%, 8.90%, 10.41% respectively, and the fuel saving rates of the three trucks in the “T₁-T₂-T₃” queue are 3.09%, 8.90% and 13.90% respectively. Combining the fuel saving rate data of each truck, the average fuel saving rate of overall platooning strategies in Table 3 can be calculated as follows:

$$\overline{Δ FC} = \frac{\begin{matrix}100 \times ( 3.09 \% \times 15 + 7.88 \% \times 15 + 13.9 \% \times 20 ) + \\ 200 \times ( 3.09 \% \times 15 + 8.9 \% \times 20 + 10.41 \% \times 20 ) + \\ 300 \times ( 3.09 \% \times 15 + 8.9 \% \times 20 + 13.9 \% \times 40 )\end{matrix}}{100 \times ( 15 + 15 + 20 ) + 200 \times ( 15 + 20 + 20 ) + 300 \times ( 15 + 20 + 40 )} = 9.48 \%$$

Therefore, the average fuel saving rate of the proposed platooning strategy in Table 3 is 9.48%, and this index can be used to evaluate the fuel saving ability of the developed platooning strategy, to judge whether the strategy is satisfactory enough.

If the platooning strategy has not be made, the method of the present disclosure can be referred to developing an optimal truck platoon strategy to minimize the fuel consumption of the whole truck queue. For example, there are 3 types of trucks as shown in Table 3 which need to operate in a platooning mode. The numbers of three types of trucks (T₁, T₂, and T₃) are 650,550 and 300, respectively. The number of trucks allowed in a truck queue is 3, that is, 3 trucks are platooned as a group. Based on the truck type and the allowed number of trucks in a queue, a total of 3³=27 types of possible truck platooning queues can be obtained, as shown in Table 4. The average fuel economy rate of each truck queue can be calculated based on the model presented in Step S2. The calculated fuel economy rates for different queues are ranked and also shown in Table 4.

TABLE 4
Fuel economy ranking of different types of truck queues

| | | Average fuel saving |
|---|---|---|
| Ranking | Platooning modes | rate Δ̅F̅C̅ (%) |
| 1 | T₁-T₃-T₃ | 11.94 |
| 2 | T₂-T₃-T₃ | 11.59 |
| 3 | T₃-T₃-T₃ | 10.88 |
| 4 | T₁-T₃-T₂ | 10.49 |
| 5 | T₁-T₂-T₃ | 10.41 |
| 6 | T₁-T₃-T₁ | 10.30 |
| 7 | T₁-T₁-T₃ | 10.29 |
| 8 | T₂-T₃-T₂ | 10.14 |
| 9 | T₂-T₂-T₃ | 10.06 |
| 10 | T₂-T₃-T₁ | 9.94 |
| 11 | T₂-T₁-T₃ | 9.93 |
| 12 | T₃-T₃-T₂ | 9.58 |
| 13 | T₃-T₂-T₃ | 9.52 |
| 14 | T₃-T₃-T₁ | 9.40 |
| 15 | T₃-T₁-T₃ | 9.39 |
| 16 | T₁-T₂-T₂ | 7.87 |
| 17 | T₂-T₂-T₂ | 7.61 |
| 18 | T₃-T₂-T₂ | 7.55 |
| 19 | T₁-T₁-T₂ | 7.46 |
| 20 | T₁-T₂-T₁ | 7.34 |
| 21 | T₃-T₁-T₂ | 7.25 |
| 22 | T₂-T₁-T₂ | 7.21 |
| 23 | T₃-T₂-T₁ | 7.18 |
| 24 | T₂-T₂-T₁ | 7.11 |
| 25 | T₃-T₁-T₁ | 6.84 |
| 26 | T₁-T₁-T₁ | 6.83 |
| 27 | T₂-T₁-T₁ | 6.62 |

Following the ranking results of the preferred truck platooning queues, the trucks are successively organized into the platooning queue with a lower fuel saving rate: Firstly, it is needed to organize the trucks into the truck queue “T₁-T₃-T₃” that ranks No. 1 in fuel economy saving. Based on the model presented in Step S3, the maximum number of this type of truck queue that can be achieved is determined as:

$${N}_{max} = min ( [ \frac{{M}_{{T}_{1}}}{{M}_{{T}_{1}}^{p}} ] , [ \frac{{M}_{{T}_{2}}}{{M}_{{T}_{2}}^{p}} ] ) = min ( [ \frac{650}{1} ] , [ \frac{300}{2} ] ) = 150$$

Thus, up to 150 groups of the 1^{st} truck queue (“T₁-T₃-T₃”) can be achieved. Those queues comprise 150 T₁-type trucks and 300 T₂-type trucks. Accordingly, the remaining trucks that need to be platooned include 500 T₁-type trucks and 550 T₂-type trucks.

Subsequently, the remaining trucks are used to form the truck queue “T₂-T₃-T₃” that ranks the 2^{nd}. The maximum number of the 2^{nd} truck queue that can be achieved is determined as 0. Similarly, the maximum numbers of the 3^{rd}, 4^{th}, . . . , 27^{th} truck queues are further calculated, until all trucks are assigned into a platoon queue.

Finally, the determined platooning strategy is summarized in Table 5, in which, this strategy is created according to the ranking results of the fuel economy of all possible truck queues. Therefore, the proposed strategy has the optimal fuel saving rate.

TABLE 5
The determined platooning strategy

| Truck queue | Number of truck queues |
|---|---|
| T₁-T₃-T₃ | 150 |
| T₁-T₂-T₂ | 275 |
| T₁-T₁-T₁ | 75 |

The various embodiments in this specification are described in a progressive manner. Each embodiment focuses on the differences from other embodiments, and the same or similar parts between the various embodiments can be referred to each other. As for the device disclosed in an embodiment, the description thereof is relatively simple since it corresponds to the method disclosed in an embodiment, and the relevant part can be referred to the description of the method part.

The above description of the disclosed embodiments enables any person skilled in the art to make or use the present disclosure. Various modifications to these embodiments will be readily apparent to those skilled in the art, and the generic principles defined herein may be implemented in other embodiments without departing from the spirit or scope of the disclosure. Thus, the present disclosure is not intended to be limited to the embodiments presented herein, but is to be accorded the widest scope consistent with the principles and novel features disclosed herein.

What is claimed:

1. A method for evaluating truck platooning strategy based on fuel saving rate, the method comprising:
S1: obtaining a truck platooning strategy, and judging whether the truck platooning strategy for organizing truck queue has been determined or not;
S2: when the truck platooning strategy has been determined, obtaining fuel-consumption-related parameters of each truck in the truck queue, then calculating the fuel saving rate of each truck in the truck queue based on the obtained parameters, then calculating an average fuel saving rate of the whole truck queue based on fuel saving rate of each truck, and finally evaluating the truck platooning strategy based on the average fuel saving rate.

2. The method for evaluating truck platooning strategy based on fuel saving rate according to claim 1, wherein, the method further comprising a step S3:
when the truck platooning strategy has not been determined, providing a tool for developing an optimal truck platooning strategy to minimize the fuel consumption of the whole truck queue;
acquiring numbers and types of all trucks that used for platooning and the allowed truck number in a truck queue, and determining all possible truck platooning queues based on the truck type and the allowed truck number in a truck queue;
calculating the average fuel saving rate of each truck platooning queue based on the procedure presented in S2;
ranking the preferred truck platooning queue based on the fuel saving rate calculation results;
organizing the trucks successively into the platooning queue with a lower fuel saving rate until all the trucks are assigned to the truck queue.

3. The method for evaluating truck platooning strategy based on fuel saving rate according to claim 2, wherein, in the step S3, a specific procedure of organizing the trucks successively into the platooning queue with a lower fuel saving rate based on a ranking result of possible truck platooning queues comprises:
determining a maximum platooning number Nₘₐₓ that can be achieved for a specific platooning queue based on type and number of all trucks that need to be platooned, by using a function as follows:
$${N}_{max} = min ( [ \frac{{M}_{{A}_{1}}}{{M}_{{A}_{1}}^{p}} ] , [ \frac{{M}_{{B}_{2}}}{{M}_{{B}_{2}}^{p}} ] , … , [ \frac{{M}_{{X}_{n}}}{{M}_{{X}_{n}}^{p}} ] )$$
where, min is minimum value function, square bracket [ ] represents rounding function, n is the allowed truck number in a truck platooning strategy, M_{A}_{₁}^{p}, M_{B}_{₂}^{p}, . . . , M_{X}_{ₙ}^{p} are numbers of different types of trucks in a specific platooning queue, and M_{A}_{₁}, M_{B}_{₂}, . . . , M_{X}_{ₙ} are numbers of different types of trucks that need to be platooned;
calculating a maximum platooning number Nₘₐₓ for each truck platooning queue based on the ranking results until all trucks are assigned into a corresponding platooning queue.

4. The method for evaluating truck platooning strategy based on fuel saving rate according to claim 1, wherein, in the step S2, a model for calculating the fuel saving rate of each truck in a truck queue is:
$$Δ FC = \frac{0.4332 * {e}^{0.0086 * S} [ a * ln ( S ) + b ] * {L}^{C}}{1 + \frac{{r}_{0} m g}{\frac{1}{2} ρ {v}^{2} A * ( 0.014 L + 0.3659 )}}$$
where, ΔFC is the fuel saving rate, L is a length of a truck, S is a spacing between two adjacent trucks, r₀ is a truck rolling coefficient, m is a weight of the truck, v is a truck velocity, ρ is an air density, A is a front area of the truck, and g is a gravity acceleration, a, b and c are fitting coefficients related to allocation of the truck in a truck queue.

5. The method for evaluating truck platooning strategy based on fuel saving rate according to claim 4, wherein, in the step S2, a model for calculating the average fuel saving rate is:
$$\overline{Δ FC} = \frac{{\sum }_{i = 1}^{n} ( Δ {FC}_{i} * {FC}_{i} )}{{{\sum }_{i = 1}}^{n} {FC}_{i}}$$
where, Δ̅F̅C̅ is the average fuel saving rate of a truck queue, n is an allowed truck number in a truck platooning strategy, ΔFCᵢ is the fuel saving rate of the ith truck in the queue, and FCᵢ is the fuel consumption of the ith truck.

6. The method for evaluating a truck platooning strategy based on fuel saving rate according to claim 5, wherein, in the step S2, the fuel-consumption-related parameters comprise any one or more of the truck's length, velocity, weight, platooning spacing distance, position in a queue, and the front area.

7. A device for evaluating truck platooning strategy based on fuel saving rate, the device comprising:
a strategy acquisition module,
a judgment module,
a first data acquisition module,
a second data acquisition module, and
an evaluation module;
the strategy acquisition module is connected to the judgment module, an output end of the judgment module is connected to input ends of the first data acquisition module and the second data acquisition module, and output ends of the first data acquisition module and the second data acquisition module are connected to the evaluation module;
the strategy acquisition module is configured to obtain the truck platooning strategy, the judgment module is configured to judge whether the truck platooning strategy has been determined or not, the first data acquisition module is configured to obtain fuel-consumption-related parameters of each truck in a truck queue, and the second data acquisition module is configured to obtain the fuel-consumption-related parameters of each truck in a corresponding truck queue when the truck platooning strategy has not been determined, and the evaluation module is configured to determine the fuel saving rate of each truck in the truck queue according to the obtained parameters, to determine an average fuel saving rate of each truck in the truck queue based on fuel saving rate of each truck, and to evaluate the truck platooning strategy based on the average fuel saving rate.

8. A computer-readable storage medium, storing a computer program for electronic data exchange, wherein, the computer program is operable to cause a computer to execute the method according claim 1.

9. A computer-readable storage medium, storing a computer program for electronic data exchange, wherein, the computer program is operable to cause a computer to execute the method according to claim 2.

10. A computer-readable storage medium, storing a computer program for electronic data exchange, wherein, the computer program is operable to cause a computer to execute the method according to claim 3.

11. A computer-readable storage medium, storing a computer program for electronic data exchange, wherein, the computer program is operable to cause a computer to execute the method according to claim 4.

12. A computer-readable storage medium, storing a computer program for electronic data exchange, wherein, the computer program is operable to cause a computer to execute the method according to claim 5.

13. A computer-readable storage medium, storing a computer program for electronic data exchange, wherein, the computer program is operable to cause a computer to execute the method according to claim 6.
